(19) United States
(12) Patent Application Publication
(10) Pub. No.: US 2004/0204056 A1
(43) Pub. Date: Oct. 14, 2004

(54) Charger with rotating pocket and detachable pocket insert

(76) Inventor: William Phelps III, Lawrenceville, GA (US)

Correspondence Address: Motorola Energy Systems Group, Law Department - attn: Zilla Higgs, 1700 Belle Meade Court, Lawrenceville, GA, 30043, US

(21) Appl. No.: 10/313,148

(22) Filed: Dec. 6, 2002

(51) Int. Cl. H04M 1/00; H04B 1/38

(52) U.S. Cl. 455/556.1; 455/573

(57) ABSTRACT

A charger is provided that includes a pocket that rotates. The charger has a base member that typically sits on a horizontal surface, like a desktop. The pocket rests in the base member upon pin-type hinge points. The pins are held in position by a trap in the base member. The pocket includes an arched member extending back from the center of the pocket. The arched member includes notched grooves that interface with a latching member in the base member. A user actuates the latching member by way of a thumb latch, thereby freeing the pocket. Once the pocket is rotated to the desired angle, the latching member is released, thereby engaging the nearest latched groove and holding the pocket at a fixed angle. The pocket may include an insert to accommodate a particular form factor. Optionally, the insert may be manufactured from an aesthetically pleasing color.

### BACKGROUND

1. Technical Field

This invention relates generally to desktop chargers for portable electronic devices, and more particularly to a desktop charger having a rotating pocket and detachable insert for accommodating portable electronic devices.

2. Background Art

Cellular phones are becoming more and more popular. While it used to be the exception to see a person talking on a cellular phone, today it is difficult to go anywhere without running into several people talking on these phones. Cellular phones derive their portability from rechargeable batteries. A typical battery will provide between three and five hours of talk time before needing to be recharged.

One of the most popular ways of recharging the battery is with a desktop charger. For example, referring to FIG. 1, illustrated therein is a typical prior art charger. The charger 100 includes a pocket 101 for accommodating an electronic device, like a cellular phone. The pocket 101 is mounted at an angle relative to the desk, so as to be easily viewable by the user. The charger includes electrical contacts 102 for coupling to the electronic device, as well as mechanical contacts 103 to ensure that the electronic device stays in the pocket 101.

While this prior art charger works well, the fixed angle of the pocket may not suit everyone. For example, many cellular phones include a caller identification read-out on the display. If the fixed angle of the prior art charger is such that the display causes glare from an overhead light to be reflected into the user's eyes, the user may have to take the phone out of the charger to read the display. Additionally, as some phones today include speakerphone functionality, it may be desirable to position the phone at an angle different from the fixed angle of the charger so as to better hear the phone's speaker.

There is thus a need for an improved battery charger having adjustability.

### BRIEF DESCRIPTION OF THE DRAWINGS

FIG. 1 illustrates a typical prior art charger.

FIG. 2 illustrates a charger in accordance with the invention.

FIG. 3 illustrates a view of the charger with the pocket rotated towards the base member to its fullest extent.

FIG. 4 illustrates a sectional view of a charger in accordance with the invention.

FIG. 5 illustrates a blown-up view of the latching member intersecting the arched member.

FIG. 6 illustrates the latching member deflected away from the pocket, causing actuation of the latching member.

FIG. 7 illustrates therein is the pocket, in a rear, left, top isometric view.

FIGS. 8 and 9 illustrate side views of the charger with the pocket in extended and retracted positions, respectively.

FIG. 10 illustrates the charger with the insert removed.

FIGS. 11 and 12 illustrate the insert rotating progressively towards the backer plate.

FIG. 13 illustrates the insert coupled to the backer plate, in the charger, in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

This invention includes a charger having a pocket that is capable of rotation so as to facilitate a wider range of visual and aural options for the user. The charger includes a pocket that adjustably rotates about a pin. The pocket adjusts by way of an arched member extending from the back of the pocket. The arched member is coupled to a cantilevered latch that mates with notched grooves in the arched member. A mechanical stop disposed upon the arched member prevents the pocket from overextending. The components of the charger are preferably constructed from injection-molded plastic.

The pocket is inserted into the top housing of the base member, and rests on pin-type hinge points. Once assembled to the top housing, the base member's bottom housing is coupled to the top housing. The base member top housing and bottom housing trap the pocket, thereby preventing them from separating. The pocket includes mechanical stops so that it is not allowed to rotate out of the base member. The pocket may rotate to a virtually infinite number of angles. The base member includes a latch member, which is used to lock the pocket at the desired angle. The latch member may be a flexible part of the pocket, or may be a separate latch part. The latch is mounted to the base member, and interfaces with notched grooves in the arched member of the pocket.

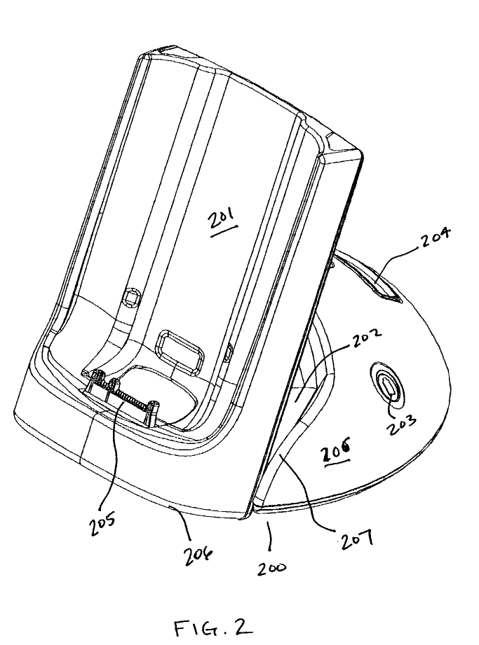

Referring now to FIG. 2, illustrated therein is a charger 200 in accordance with the invention. The charger includes a base member 206 and a pocket 201. The pocket 201 is designed so as to accommodate a portable electronic device. Note that the pocket 201 is not a supporting plate, but rather a full pocket with a bottom and sides to cradle a portable electronic device. The pocket 201 includes charging terminals 205 that couple electrically by way of a flexible circuit to charging circuitry disposed within the charger. The charger 200 optionally includes a second pocket 204 for charging a spare battery, and an indicator 203 to provide feedback to the user regarding the state of charge.

The pocket 201 is rotatably adjustable, with the lower portion 206 of the pocket 201 being coupled to the base member 203 by way of a hinge disposed within the base member 203. The hinge creates a fixed pivot point about which the pocket 201 rotates. As the pocket 201 rotates, an arched member 202, which preferably spans the width of the pocket 201, moves in and out of an aperture 207 in the base member 206.

Referring to FIG. 3, illustrated therein is a view of the charger 200 with the pocket 201 rotated towards the base member 206 to its fullest extent. Note that the arched member (not shown in FIG. 3) has moved completely within the aperture 207 of the base member 206. Adjusting the pocket 201 allows a user to rotate the pocket for optimum aural effect, in the case of speakerphones, and optimum visual effect, in the case of electronic devices having displays.

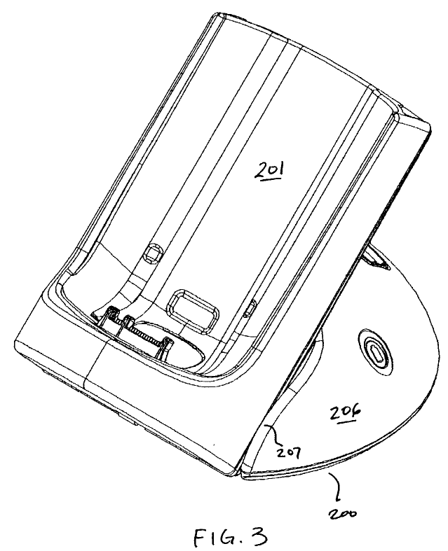

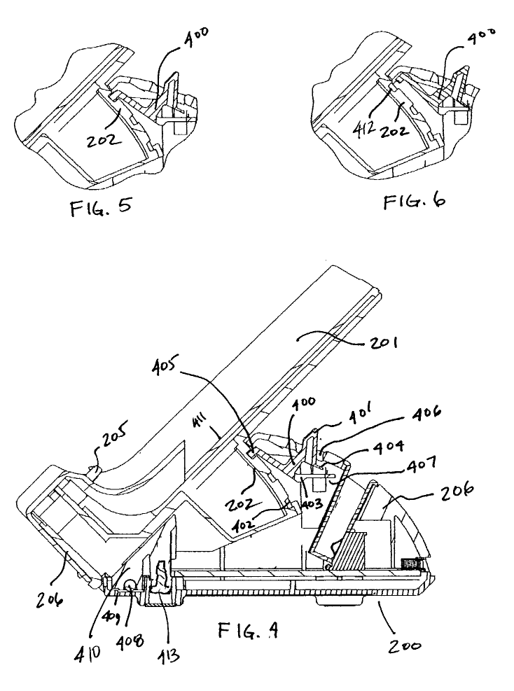

Referring now to FIG. 4, illustrated therein is a sectional view of a charger 200 in accordance with the invention. The pocket 201 couples to the base member 206 by way of a pin 408 that is mechanically disposed upon the pocket 201. The pin 408 mates with a trap 410, thereby securing the pin 408 between the trap 410 and the lower housing 409 of the base member 206. The base member 206, for ease of tooling, preferably includes an upper and lower housing, with the trap 401 coupled to the upper housing. A screw 413 preferably couples the upper and lower housings, although other attachment means may equally be used.

The arched member 405 is preferably disposed towards the center 411 of the pocket 201. The arched member 202 includes notched grooves, e.g. 402, that mate with a latch 405 of a latching member 400. The latching member 400 includes a thumb lever 401 that protrudes through an aperture 406 in the base member 206. The latching member 400 includes a mechanical stop 404 to prevent the latching member 400 from overextending beyond the lower housing 206.

The latching member 400 is preloaded against the arched member 202 by way of a cantilevered hinge 403 that is braced in the base member at point 407. The cantilevered hinge 403 allows the latching member 400 to deflect away from the pocket 201, thereby freeing the latch 407 from the notched grove. This allows the pocket 201 to rotate. FIG. 5 illustrates a blown-up view of the latching member 400 intersecting with the arched member 202. FIG. 6 shows the latching member 400 deflected away from the pocket, causing the latching member 400 to be freed from the notched groove 412.

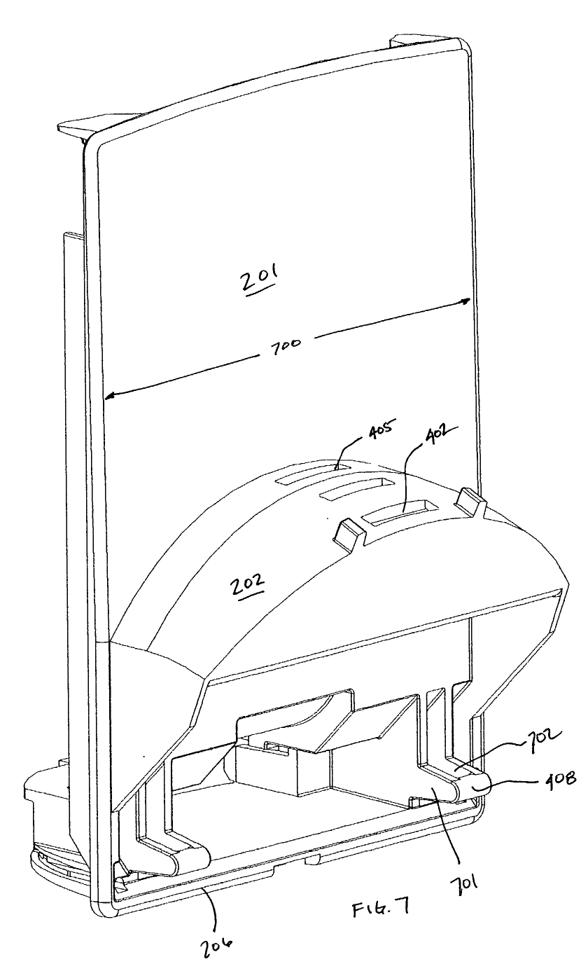

Referring now to FIG. 7, illustrated therein is the pocket 201, in a rear, left, top isometric view. This view illustrates the detail of the arched member 202, including the notched grooves 402,405. Note that while this embodiment employs three notched grooves, it will be clear to those of ordinary skill in the art that the invention is not so limited. Any number of notched grooves may be added to enhance the rotational resolution.

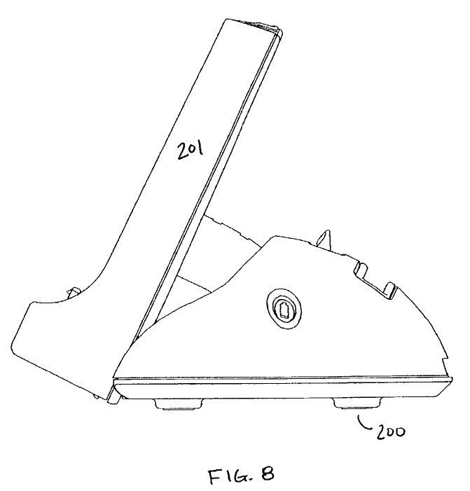

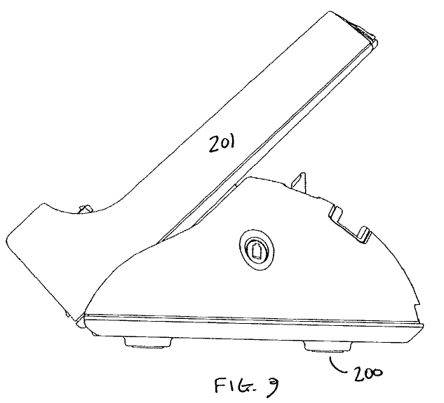

Note that the arched member 202 preferably spans the width 700 of the pocket 201. The arched member is so designed as to match with the aperture in the lower member. In FIG. 7, the pin 408 and the corresponding attachment means 701 to the pocket 201 are also illustrated. The pin 408 is preferably “U” shaped, leaving a void 702 through which the trap of the base member may be inserted. The pocket 201 rotates about the pins 408. FIGS. 8 and 9 illustrate side views of the charger 200 with the pocket 201 in extended and retracted positions, respectively.

An optional feature of this particular charger is pocket interchangeability. Not all electronic devices have the same form factor. Additionally, people often prefer to customize the color and appearance of their electronic devices. The charger of this invention includes a detachable insert that accommodates these requirements.

Referring now to FIG. 10, illustrated therein is the charger 200 with the insert 802 removed. Note that in FIG. 10, the pocket, which was referred to as element 201 in the preceding figures, is shown as insert 802 and backer plate 803. Insert 802 is customizable, in that insert 802 may be tooled to accommodate an number of electronic device form factors. Additionally, insert 802 may be tooled in any number of aesthetically pleasing colors. A dramatic effect is created when backer plate 803 is tooled in a metallic color and insert 803 is tooled with clear plastic. A deep, glossy finish results.

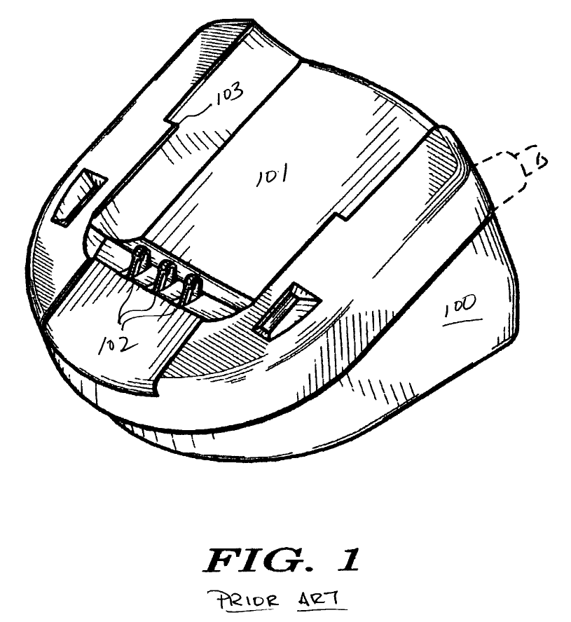

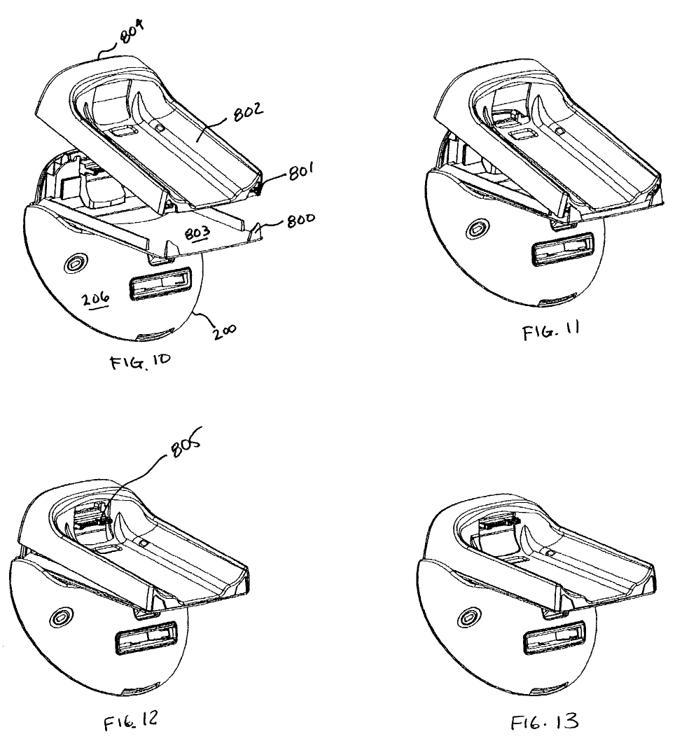

Insert 802 is coupled to the backer plate 803 by way of a hook and latch mechanism. Insert 802 includes at least one recess 801 into which a hook 800 is inserted. The bottom 804 of the insert is then rotated towards the electrical contacts 805 as illustrated in progressive FIGS. 1I and 12. At FIG. 13, a ramped shape latch (not shown) on the bottom of the backer plate 803 interconnects with an aperture (not shown) on the insert 802, thereby forming a secure mechanical coupling.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. For example, while cellular phones have been used herein as exemplary electronic devices, the charger may equally accommodate pagers, radios, personal digital assistants, portable music players and the like.

What is claimed is:

1. A charger for an electronic device having a rechargeable battery, the charger comprising:
a. a base member;
b. a pocket for accommodating the electronic device, the pocket comprising:
i. means for coupling to the base member, the means for coupling being disposed towards a bottom portion of the pocket; and
ii. an arched member, the arched member being disposed towards the center of the pocket, the arched member comprising at least one notched groove;
c. a latching member having a cantilever action, the latching member being mechanically coupled to the base member with the cantilever action providing a preload force against the arched member.

2. The charger of claim 1, wherein the latching member further comprises a finger actuated lever coupled to the latching member, wherein the finger actuated lever protrudes through an aperture in the base member.

3. The charger of claim 2, wherein when the finger actuated lever is actuated, the preload force of the latching member is removed from the arched member.

4. The charger of claim 3, wherein the pocket comprises at least one pin mechanically coupled to the pocket.

5. The charger of claim 4, wherein the base member comprises at least one trap for receiving the at least one pin of the pocket.

6. The charger of claim 5, wherein the pocket comprises:
a. an insert, wherein the insert comprises at least one recess for receiving a hook and at least one aperture for receiving a latch; and
b. a backer plate, wherein the backer plate comprises at least one hook and at least one ramp shaped latch.

7. The charger of claim 6, wherein the insert is manufactured from a transparent material, further wherein the backer plate is manufactured from a colored material.

8. The charger of claim 7, wherein the insert is shaped so as to accommodate a form factor of a portable electronic device.
